(19) United States
(12) Patent Application Publication
(10) Pub. No.: US 2007/0136609 A1
(43) Pub. Date: Jun. 14, 2007

(54) Methods and apparatus for providing a secure channel associated with a flash device

(76) Inventors: John C. Rudelic, Folson, CA (US); John P. Brizek, Placerville, CA (US); Robert Hasbun, Fall City, WA (US)

Correspondence Address: INTEL CORPORATION;C/O INTELLEVATE, LLC, P.O. BOX 52050, MINNEAPOLIS, MN, 55402, US

(21) Appl. No.: 11/300,103

(22) Filed: Dec. 13, 2005

(51) Int. Cl. G06F 12/14

(52) U.S. Cl. 713/193

(57) ABSTRACT

Embodiments of methods and apparatus for providing a secure channel associated with a flash device are generally described herein. Other embodiments may be described and claimed.

### TECHNICAL FIELD

The present disclosure relates generally to flash memory systems, and more particularly, to methods and apparatus for providing a secure channel associated with a flash device.

### BACKGROUND

Typically, a flash memory may be well suited for wireless electronic devices such as cellular telephones because a flash memory may retain digital information without power. In particular, a flash memory (e.g., a flash random access memory (RAM)) is a non-volatile memory that may be erased or written in units of blocks. Instead of erasing or writing at a byte level such as an electrically erasable programmable read-only memory (EEPROM), a flash memory may update or change stored data faster by erasing or writing in block sizes.

### BRIEF DESCRIPTION OF THE DRAWINGS

FIG. 1 is a schematic diagram representation of an example flash memory system according to an embodiment of the methods and apparatus disclosed herein.

FIG. 2 depicts one example of a secure channel initialization system.

FIG. 3 depicts one example of a secure channel operation system.

FIG. 4 is a flow diagram representation of one manner to initialize a secure channel.

FIG. 5 is a flow diagram representation of one manner to operate a secure channel.

FIG. 6 is a block diagram representation of an example processor system that may be used to implement an example flash memory system of FIG. 1.

### DETAILED DESCRIPTION

In general, methods and apparatus for providing a secure channel associated with a flash device are described herein. The methods and apparatus described herein are not limited in this regard.

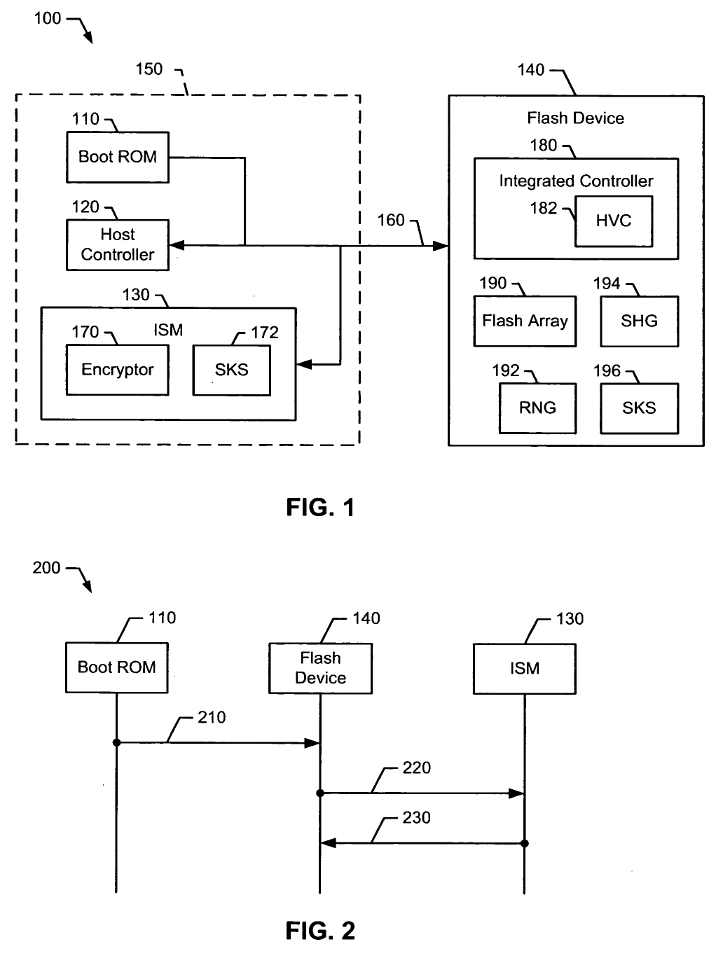

Referring to FIG. 1, an example flash memory system 100 may include a boot read-only memory (ROM) 110, a host controller 120, an integrated security module (ISM) 130, and a flash device 140. In general, the flash memory system 100 may be implemented in an electronic device (not shown). For example, the flash memory system 100 may be implemented in a desktop computer, a network server, a laptop computer, a handheld computer, a tablet computer, a cellular telephone (e.g., a smart phone), a pager, an audio and/or video player (e.g., an MP3 player or a DVD player), a gaming device, a digital camera, a navigation device (e.g., a global position system (GPS) device), a medical device (e.g., a heart rate monitor, a blood pressure monitor, etc.), and/or other suitable relatively stationary, mobile, and/or portable electronic devices.

While the boot ROM 110, the host controller 120, and the integrated security module 130 are depicted as separate blocks, these components may be integrated within a central processing unit (CPU) 150. The CPU 150 may be operatively coupled to the flash device 140 via a flash interface 160. For example, the flash interface 160 may include a bus, and/or a direct link between the boot ROM 110, the host controller 120, the integrated security module 130, and the flash device 140.

In general, the boot ROM 110 may provide boot code to the flash device 140 for initializing a secure channel between the integrated security module 130 and the flash device 140. To protect against threats such as viruses, worms, or bad code, for example, the integrated security module 130 and the flash device 140 may use the secure channel to authenticate an operation (e.g., a command from the integrated security module 130). For example, the operation may be a read operation, a write operation, a patch operation, a key operation, and/or other suitable operations. As described in detail below, the secure channel may operate in accordance with a hash-based authentication algorithm instead of an asymmetric authentication algorithm (e.g., public key encryption developed by Rivest, Shamir, and Adleman (RSA)) to increase performance of the flash memory system 100.

The host controller 120 (e.g., an application processor) may perform a variety of operations for the CPU 150. For example, the host controller 120 may process operations ranging from running an operating system (OS) or an application to invoking the boot ROM 110 as mentioned above.

The integrated security module 130 may include an encryptor 170 and a secure key storage 172. In general, the integrated security module 130 may be a dedicated module to process security operations. For example, the host controller 120 may offload security operations to the integrated security module 130 so that the host controller 120 may be available for other processing associated with the flash memory system. As described in detail below, the encryptor 170 may encrypt or wrap a cryptographic key generated and provided by the flash device 140. The secure key storage 172 may locally store the encrypted key from the encryptor 170 at the integrated security module 130.

The flash device 140 may include an integrated controller 180, a flash array 190, a random number generator (RNG) 192, a secure hash generator (SHG) 194, and a secure key storage (SKS) 196. In general, the flash device 140 may internally authenticate operations to protect itself against malicious and/or inadvertent modifications. Prior to performing a requested operation such as read, write, patch, key, and/or other suitable operations, the flash device 140 may authenticate the requested operation internally. If the requested operation is authentic, the flash device 140 may perform the operation. Otherwise if the requested operation is not authentic, the flash device 140 may disregard the request.

As described in detail below, the integrated controller 180 may initialize a secure channel between the integrated security module 130 and the flash device 140, and process a command request from the integrated security module 130 in response to receipt of the command request via the secure channel. Briefly, the integrated controller 180 may also include a hash value comparator (HVC) 182 to compare hash values generated by the integrated security module 130 and the flash device 140. The flash array 190 may store data, code, and/or other suitable information. The random number generator 192 may generate a nonce value, which may be provided to the integrated security module 130 to generate the encrypted key. The secure hash generator 194 may generate the cryptographic key, which may also be provided to the integrated security module 130 to generate the encrypted key. The secure key storage 196 may locally store the cryptographic key at the flash device 140. The secure key storage 196 may also store the encrypted key from the integrated security module 130. The methods and apparatus described herein are not limited in this regard.

While the components shown in FIG. 1 are depicted as separate blocks within the flash device 140, the functions performed by some of these blocks may be integrated within a single semiconductor circuit or may be implemented using two or more separate integrated circuits. For example, although the random number generator 192 and the secure hash generator 194 are depicted as separate blocks within the flash device 140, the random number generator 192 and the secure hash generator 194 may be integrated into a single component. The methods and apparatus described herein are not limited in this regard.

To protect against threats/attacks (e.g., viruses, worms, or bad code) and/or to increase performance, the flash memory system 100 may include a secure channel between the integrated security module 130 and the flash device 140. In the example of FIG. 2, a secure channel initialization system 200 may begin with the boot ROM 110 providing the flash device 140 with a command to generate a cryptographic key (210). In one example, the flash device 140 (e.g., via the random number generator 192 and/or the secure hash generator 194) may generate a keyed-hash message authentication code (HMAC) key. The flash device 140 (e.g., via the integrated controller 160) may store the HMAC key in the secure key storage 196. The flash device 140 may provide the HMAC key to the integrated security module 130 (220).

The integrated security module 130 (e.g., via the encryptor 170) may encrypt or wrap the HMAC key (e.g., a wrapped HMAC key). For example, the encryptor 170 may operate in accordance with encryption standards developed by the National Institute of Standards and Technology (NIST) such as Advanced Encryption Standard (AES) (published Nov. 26, 2001), Data Encryption Standard (DES) (published Jan. 15, 1977), variations and/or evolutions of these standards, and/or other suitable encryption standards, algorithms, or technologies. Accordingly, the integrated security module 130 may store the wrapped HMAC key in the secure key storage 172 and also in the secure key storage 196 of the flash device 140. In one example, the integrated security module 130 may use write operations to store the wrapped HMAC key in the flash device 140. External devices relative to the flash memory system 100 and/or other components of the flash memory system 100 (e.g., the host controller 120) do not have or know the wrapped HMAC key shared between the integrated security module 130 and the flash device 140. As a result, the secure channel between the integrated security module 130 and the flash device 140 may be used to protect against malicious or inadvertent modifications. The methods and apparatus described herein are not limited in this regard.

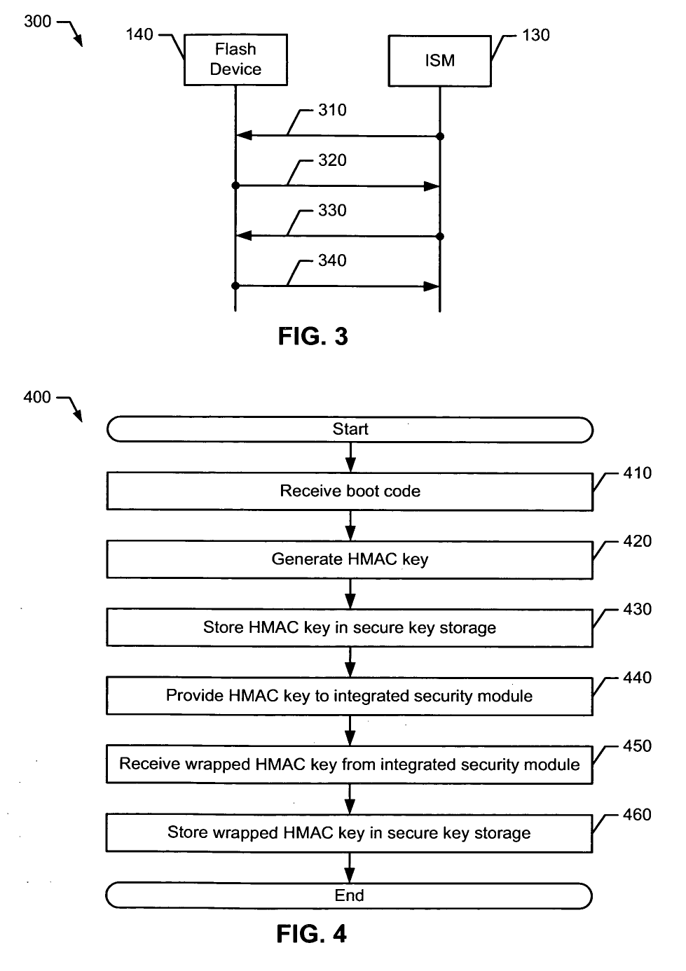

With a secure channel initialized as described in connection with FIG. 2, for example, a secure channel operation system (e.g., the secure channel operation system 300) may process a command request from the integrated security module 130. Turning to FIG. 3, for example, the secure channel operation system 300 may begin with the integrated security module 130 generating a command request to the flash device 140. The command request may be associated with a command or an operation such as, for example, write, read, patch, and/or other suitable operations. Accordingly, the integrated security module 130 may provide the command request to the flash device 140 (310).

In response to receipt of the command request from the integrated security module 130, the flash device 140 (e.g., via the random number generator 192) may generate a nonce value. For example, the nonce value may be a random or pseudo-random number to protect against-replay attacks in which valid data transmission is maliciously or fraudulently replayed or delayed. The flash device 140 may provide the integrated security module 130 with the nonce value (320).

Based on the wrapped HMAC key as described in connection with the secure channel initialization system 200 of FIG. 2, the integrated security module 130 may generate a first hash value associated with the command. Accordingly, the integrated security module 130 may provide the flash device 140 with the command, the first hash value, and the nonce value (330).

To determine whether the command is from the integrated security module 130, the flash device 140 (e.g., via the integrated controller 180 and/or the secure hash generator 194) may generate a second hash value associated with the command based on the wrapped HMAC key generated by the secure channel initialization system 200 of FIG. 2. As noted above, the integrated security module 130 may provide the wrapped HMAC key, and the flash device 140 may store the wrapped HMAC key in the secure key storage 196.

To identify a condition indicative of authenticity associated with the command from the integrated security module 130, the flash device 140 (e.g., via the hash value comparator 182 of the integrated controller 180) may compare the second hash value with the first hash value from the integrated security module 130. If the first and second hash values are identical, the flash device 140 may determine that the command is from the integrated security module 130 (e.g., the command is authentic). Accordingly, the flash device 140 may perform the command of the command request from the integrated security module 130. Otherwise if the first and second hash values are not identical, the flash device 140 may not perform the command of the command request.

The flash device 140 may generate and provide a response to the integrated security module 130 (340). The response may indicate the status of the command request. Based on the response, the integrated security module 130 may determine whether the flash device 140 performed the command of the command request or rejected the command request.

Although the above examples are described with respect to a HMAC key, the methods and apparatus described herein may use other suitable cryptographic keys, message authentication codes, and/or digital signatures. Further, although a particular order of actions is illustrated in FIGS. 2 and 3, these actions may be performed in other temporal sequences. For example, the actions illustrated in FIGS. 2 and/or 3 may be executed repetitive, serial, and/or parallel manners. The methods and apparatus described herein are not limited in this regard.

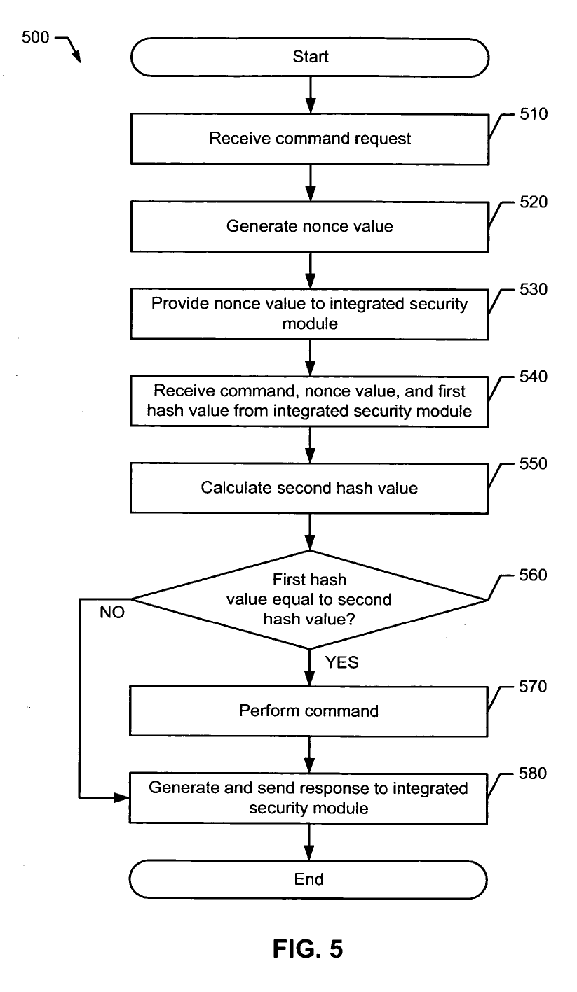

FIGS. 4 and 5 depict one manner in which the example flash memory system 100 of FIG. 1 may be provide a secure channel associated with a flash device (e.g., the flash device 140 of FIG. 1). The example processes 400 and 500 of FIGS. 4 and 5, respectively, may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable. programmable read only memory (EPROM), a ROM, a RAM, a magnetic media, an optical media, and/or any other suitable type of medium.

Further, although a particular order of actions is illustrated in FIGS. 4 and 5, these actions may be performed in other temporal sequences. For example, the actions illustrated in FIGS. 4 and/or 5 may be executed repetitive, serial, and/or parallel manners. Again, the example processes 400 and 500 are merely provided and described in conjunction with the apparatus of FIGS. 1, 2, and/or 3 as an example of one way to provide a secure channel associated with a flash device.

In the example of FIG. 4, the process 400 may begin with the flash device 140 receiving boot code from the boot ROM 110 (block 410). The boot code may instruct the flash device 140 to generate a cryptographic key (e.g., an HMAC key) to initialize a secure channel between the integrated security module 130 and the flash device 140. Accordingly, the flash device 140 (e.g., via the integrated controller 180 and/or the secure hash generator 194) may generate the HMAC key (block 420). In one example, the HMAC key may be generated based on a secure hash algorithm (SHA) (e.g., SHA-1), a message-digest algorithm (e.g., MD5), other suitable cryptographic hash algorithms, and/or a random value generated by the random number generator 192. The flash device 140 may store the HMAC key in the secure key storage 196 (block 430). As described in detail below, the HMAC key may be retrieved from the secure key storage 196 to calculate a hash value.

Further, the flash device 140 may provide the HMAC key to the integrated security module 130 (block 440). The integrated security module 130 may encrypt (e.g., wrap) the HMAC key from the flash device 140. In particular, the encryptor 170 may encrypt the HMAC key to produce a wrapped HMAC key, and the secure key storage 172 may store the wrapped HMAC key. The integrated security module 130 may provide the wrapped HMAC key to the flash device 140.

As noted above, the flash device 140 may receive the wrapped HMAC key from the integrated security module 130 (block 450). Accordingly, the flash device 140 may store the HMAC key in the secure key storage 196 (block 460). As a result, a secure channel between the integrated security module 130 and the flash device 140 has been initialized to communicate command requests for processing as described in connection with FIG. 5. The methods and apparatus described herein are not limited in this regard.

Turning to FIG. 5, for example, the process 500 may begin with the flash device 140 receiving a command request from the integrated security module 130 (block 510). In particular, the command request may be associated with a command such as read, write, patch, key, and/or other suitable operations. As described in detail below, the flash device 140 may determine whether to perform the command from the integrated security module 130.

The flash device 140 (e.g., via the random number generator 192 and/or the secure hash generator 194) may generate a nonce value (block 520). As noted above, the nonce value may be a random number or a pseudo-random number that is used once to protect against replay attacks. The flash device 140 may provide the nonce value to the integrated security module 130 (block 530). Based on the nonce value from the flash device 140 and the wrapped HMAC key stored in the secure key storage 172, the integrated security module 130 may generate a first hash value associated with the command of the command request. Accordingly, the integrated security module 130 may provide the command, the first hash value, and the nonce value to the flash device 140 for processing.

As noted above, the flash device 140 may receive the command, the first hash value, and the nonce value from the integrated security module 130 (block 540). Based on the wrapped HMAC key stored in the secure key storage 196, the flash device 140 (e.g., via the integrated controller 180 and/or the secure hash generator 194) may generate a second hash value associated with the command of the command request (block 550). To determine the authenticity of the command, the flash device 140 (e.g., via the hash value comparator 182 of the integrated controller 180) may compare the first and second hash values (block 560). That is, the flash device 140 may determine whether the command is from the integrity security module 130 and whether the flash device 140 received the command from the integrity security module 130 in a timely manner. If the first hash value is equal to the second hash value, the flash device 140 (e.g., via the integrated controller 180) may perform the command as requested by the integrated security module 130 (block 570). The flash device 140 may send a response indicative of the status of the command to the integrated security module 130 (block 580). For example, the response may indicate that the flash device 140 performed, is currently performing, or will perform the command.

Otherwise if the first and second hash values are different at block 560, control may proceed directly to block 580. In one example, the response may indicate that the flash device 140 rejected the command request and did not perform the command. The methods and apparatus described herein are not limited in this regard.

While the methods and apparatus disclosed herein are described in FIG. 5 to operate in a particular manner, the methods and apparatus disclosed herein are readily applicable without certain blocks depicted in FIG. 5. In addition, while FIG. 5 depicts particular blocks, the actions performed by some of these blocks may be integrated within a single block or may be implemented using two or more separate blocks.

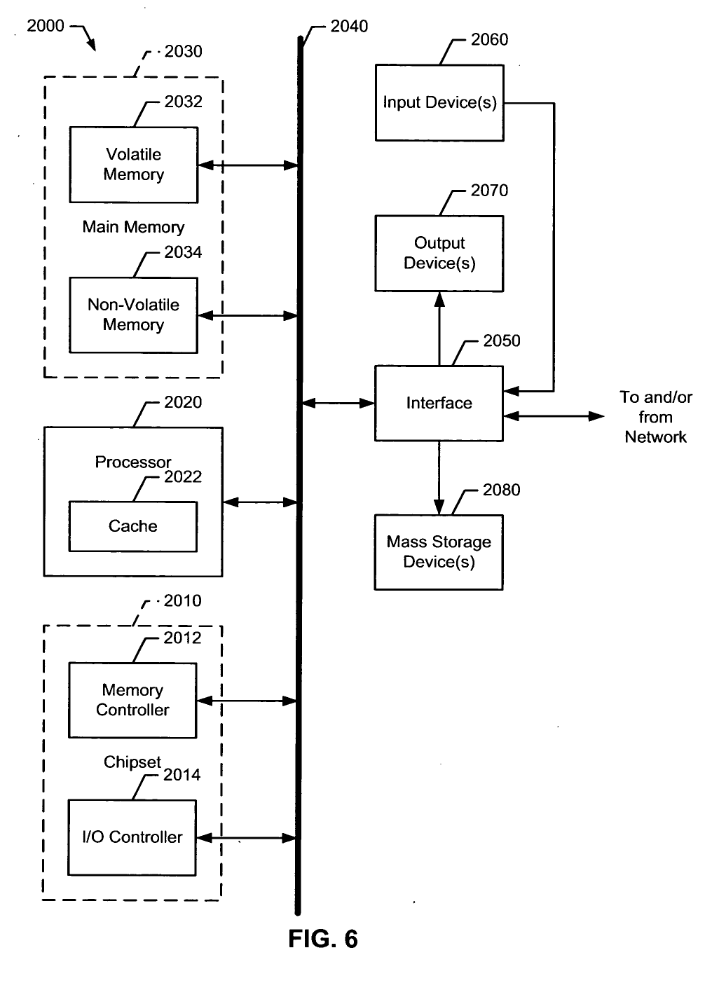

FIG. 6 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 6 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 6 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the .contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
initializing a secure channel between a flash device and an integrated security module of a processing unit based on a cryptographic key, the flash device being operatively coupled to the processing unit via a flash interface; and
processing a command request from the integrated security module at the flash device via the secure channel, the command request being associated with a command from the integrated security module.

2. A method as defined in claim 1, wherein initializing the secure channel comprises generating the cryptographic key at the flash device and providing the cryptographic key to the integrated security module to generate an encrypted key.

3. A method as defined in claim 1, wherein initializing the secure channel comprises storing an encrypted key at the flash device in response to receipt of the encrypted key from the integrated security module, and wherein the encrypted key is based on the cryptographic key.

4. A method as defined in claim 1, wherein processing the command request comprises generating a nonce value at the flash device in response to receipt of the command request from the integrated security module.

5. A method as defined in claim 1, wherein processing the command request comprises generating a first hash value at the flash device in response to receipt of at least one of a command, a nonce value, or a second hash value from the integrated security module, wherein the first hash value is based on an encrypted key, and wherein the encrypted key is based on the cryptographic key.

6. A method as defined in claim 1, wherein processing the command request comprises identifying a condition indicative of authenticity of a command at the flash device based on a comparison of a first hash value and a second hash value, and wherein the first hash value is associated with the flash device and the second hash value is associated with the integrated security module.

7. A method as defined in claim 1, wherein processing the command request comprises performing the command at the flash device in response to a comparison of a first hash value and a second hash value, wherein the first hash value is associated with the flash device and the second hash value is associated with the integrated security module.

8. A method as defined in claim 1, wherein processing the command request comprises rejecting the command request at the flash device in response to a comparison of a first hash value and a second hash value, wherein the first hash value is associated with the flash device and the second hash value is associated with the integrated security module.

9. A method as defined in claim 1 further comprising generating a response associated with the command request at the flash device, and wherein the response is indicative of the status of the command request.

10. An article of manufacture including content, which when accessed, causes a machine to:
generate a cryptographic key at a flash device, the flash device being operatively coupled to a processing unit via a flash interface;
store an encrypted key associated with a secure channel from an integrated security module of the processing unit, the encrypted key being based on the cryptographic key; and
process a command request from the integrated security module at the flash device via the secure channel, the command request is associated with a command from the integrated security module.

11. An article of manufacture as defined in claim 10, wherein the content, when accessed, causes the machine to transmit the cryptographic key to the integrated security module.

12. An article of manufacture as defined in claim 10, wherein the content, when accessed, causes the machine to process the command request by generating a nonce value at the flash device in response to receipt of the command request from the integrated security module.

13. An article of manufacture as defined in claim 10, wherein the content, when accessed, causes the machine to generate a first hash value at the flash device in response to receipt of at least one of a command, a nonce value, or a second hash value from the integrated security module, and wherein the first hash value is based on the encrypted key.

14. An article of manufacture as defined in claim 10, wherein the content, when accessed, causes the machine to process the command request by comparing a first hash value and a second hash value at the flash device, and wherein the first hash value is associated with the flash device and the second hash value is associated with the integrated security module.

15. An article of manufacture as defined in claim 10, wherein the content, when accessed, causes the machine to process the command request by performing the command at the flash device in response to a comparison of a first hash value and a second hash value, wherein the first hash value is associated with the flash device and the second hash value is associated with the integrated security module.

16. An article of manufacture as defined in claim 10, wherein the content, when accessed, causes the machine to process the command request by rejecting the command request at the flash device in response to a comparison of a first hash value and a second hash value, wherein the first hash value is associated with the flash device and the second hash value is associated with the integrated security module.

17. An article of manufacture as defined in claim 10, wherein the content, when accessed, causes the machine to generate a response associated with the command request at the flash device, and wherein the response is indicative of the status of the command request.

18. An apparatus comprising:
a flash array; and
a controller integrated with the flash array to initialize a secure channel between a flash device and an integrated security module of a processing unit based on a cryptographic key, and to process a command request from the integrated security module at the flash device via the secure channel,
wherein the flash device is operatively coupled to the processing unit via a flash interface, and
wherein the command request is associated with a command from the integrated security module.

19. An apparatus as defined in claim 18, wherein the cryptographic key comprises a keyed-hash message authentication code (HMAC) key.

20. An apparatus as defined in claim 18 further comprising a secure key storage to store at least one of the cryptographic key or an encrypted key, wherein the encrypted key is based on the cryptographic key.

21. An apparatus as defined in claim 18 further comprising a secure hash generator to generate a first hash value based on an encrypted key, wherein the encrypted key is based on the cryptographic key.

22. An apparatus as defined in claim 18, wherein the integrated controller comprises a hash value comparator to compare a first hash value and a second hash value, and wherein the first hash value is associated with the flash device and the second hash value is associated with the integrated security module.

23. An apparatus as defined in claim 18, wherein the integrated controller performs the command at the flash device in response to a comparison of a first hash value and a second hash value, wherein the first hash value is associated with the flash device and the second hash value is associated with the integrated security module.

24. An apparatus as defined in claim 18, wherein the integrated controller rejects the command request at the flash device in response to a comparison of a first hash value and a second hash value, wherein the first hash value is associated with the flash device and the second hash value is associated with the integrated security module.

25. An apparatus as defined in claim 18, wherein the integrated controller generates a response associated with the command request at the flash device, and wherein the response is indicative of the status of the command request.

26. A system comprising:
a processor having an integrated security module; and
a flash memory operatively coupled to the processor via a flash interface, the flash memory having an integrated controller to initialize a secure channel between the flash device and an integrated security module based on a cryptographic key, and to process a command request from the integrated security module at the flash memory via the secure channel, the command request being associated with a command from the integrated security module.

27. A system as defined in claim 26, wherein the integrated controller generates a first hash value at the flash memory in response to receipt of at least one of a command, a nonce value, or a second hash value from the integrated security module, wherein the first hash value is based on a encrypted key, and wherein the encrypted key is based on the cryptographic key.

28. A system as defined in claim 26, wherein the integrated controller identifies a condition indicative of authenticity of a command at the flash device based on a comparison of a first hash value and a second hash value, and wherein the first hash value is associated with the flash device and the second hash value is associated with the integrated security module.

29. A system as defined in claim 26, wherein the integrated controller performs the command at the flash device in response to a comparison of a first hash value and a second hash value, wherein the first hash value is associated with the flash device and the second hash value is associated with the integrated security module.

30. A system as defined in claim 26, wherein the integrated controller rejects the command request at the flash device in response to a comparison of a first hash value and a second hash value, wherein the first hash value is associated with the flash device and the second hash value is associated with the integrated security module.
